(19) United States
(12) Patent Application Publication
(10) Pub. No.: US 2004/0148527 A1
(43) Pub. Date: Jul. 29, 2004

(54) Method for the management of a configuration of a gateway by a user of the gateway

(76) Inventor: Jean-Philippe Wary, Bourg La Reine (FR)

Correspondence Address: PERMAN & GREEN, LLP, 425 Post Road, Fairfield, CT, 06824, US

(21) Appl. No.: 10/664,257

(22) Filed: Sep. 17, 2003

(30) Foreign Application Priority Data
Sep. 24, 2002 (FR) 0211805

(51) Int. Cl. H04L 9/00

(52) U.S. Cl. 713/202

(57) ABSTRACT

In order to offer the greatest possible flexibility in the configuration of privacy management, a recording in a database (112) is associated with each user. This database is addressed by a user identifier (IDU). It enables the definition of a isolating identifier nature (113.b) that has to be produced, by a service provider, for the user as a function of a content provider to which the user wishes to link up through the service provider. This database also enables the validation of the service requests sent by a content provider for a user X. This database enables an association between a pair formed by a user and a content provider and a list (113.c) of authorized services. A service request is validated only if the required service is present in a list determined from the pair consisting of the user X and the content provider.

### BACKGROUND OF THE INVENTION

1. Field of the Invention

An object of the invention is a method for the management of a configuration of behavior of the gateway of a service provider according to the wishes of a user accessing a content provider through a gateway of this service provider. The field of the invention is that of providing access to multimedia networks such as the Internet. In particular, the field of the invention is that of mobile telephony operators enabling their subscribers to access servers of content providers. It is an aim of the invention to enable a user who is a subscriber to a service in a multimedia network to maintain his privacy. It is another aim of the invention to enable this very same user to parametrize the management of his privacy. It is another aim of the invention to enable content providers to manage context as a function of an identity of the user.

2. Description of the Prior Art

In the prior art, there are several means by which the content provider can identify a user who accesses one of its services. These means depend on the medium used by the user to access the service. Mainly four modes of access can be distinguished, but the list is not exhaustive. A first mode of access is that of Internet-type access. The Internet access mode can itself be divided into two sub-modes which may be called the connected mode and the unconnected mode. The connected Internet mode is a connection mode using an HTTP (Hyper Text Transfer Protocol) or WTP (Wireless Transfer Protocol) type of protocol. A server, for example a HTTP server, is an apparatus communicating with a network, for example the Internet, according to the HTTP protocol. Such a server hosts Web (Internet) or WAP (Wireless Application Protocol) type networks. There is also an unconnected Internet access mode using an SMTP (Simple Mail Transfer Protocol) type protocol in which the connection actually consists of an exchange of mail-type electronic messages.

Another access mode is a mode of access by operator. This mode itself is also subdivided into two sub-modes. A first access sub-mode, which constitutes a third access mode, is then an access mode that may be called an unconnected mode. This mode uses an SMS (Short Message Service) or MMS (Multimedia Message Service) type protocol. A fourth access mode is a connected mode of access by operator also known as a voice mode in which the accessing user links up with a voice server.

All four access modes have a simple type of solution which consists in making an interface that proposes the keying in of an identifier and a password during a connection to a server. Inasmuch as the user linking up with the server of the content provider does so through a mobile telephone, the means made available to the user in order to key in his identifier (or login username) and password are limited by the user interface of the telephone. Either the identifier and the password are totally numerical, in which case they are difficult to memorize and easy to guess, or the identifier and the password are alphanumerical, in which case it is a tedious task to enter them with a keypad having only nine keys. Furthermore, this keying-in step is an additional step for the user and, in most cases, discourages a mobile telephone user from linking up with a site that offers a connection interface of the type using an identifier and password.

Another approach, in the case of servers of the first type, consists in using a cookie. A cookie is a small file recorded in the user's machine. During a connection to a content provider, this content provider can access this cookie to identify the user. One problem with this approach lies in the fact that it is possible to steal a cookie by electronic or other means. The use of a cookie is therefore not compatible with high security requirements. Another problem then lies in the fact that cookies have a relatively poor reputation. This incites users to erase them. Furthermore, the user may configure the application, or navigator, that he uses to link up with the content provider, so that this application does not accept cookies. In this case, the user is unable to link up with the server of the content provider.

For the third and fourth access modes, the content provider most usually has access to the telephone number of the person calling the server. The content provider is therefore capable of identifying the person through this telephone number. This is bound to raise a problem of protection of privacy. Indeed, it is quite conceivable that the user should wish not to be physically identified when he or she links up with the server of the content provider. It is then possible to try and link up in masking one's number. However, in this case, it is impossible for the service to be invoiced and hence for the connection to be made. At present, the only solution therefore consists in not linking up with this content provider.

It is therefore seen that, in the prior art, either the user linking up with a server of the content provider is fully identified through his telephone number, or the user must remember an identifier and a password for each content provider. The former case may be deemed to be a serious infringement of the user's privacy. In the latter case, managing all these identifiers often discourages the user. Most often, the consequence of this is that the user who makes connection several times to a same site will prefer to recreate a new identifier and a new password because he will have forgotten the ones used during his previous connection.

In the invention, these problems are resolved by centralizing the management of the privacy of a user subscribing to a service provider at a gateway. This gateway uses a configuration file to define the behavior that the subscriber wishes the gateway to adopt. This configuration file can be accessed and modified by the user at will. Such a configuration file enables the definition, for each content provider, of the type of identifier that the user wishes to present to the content provider, and the services that the user agrees should be placed by the operator at the content provider's disposal.

The types of identifiers that the gateway 103 can produce/present are isolating identifiers. They are temporary identifiers or session identifiers, having lifetimes limited to a few minutes, context identifiers which have far longer lifetimes, ranging from six months to many years, or personalized identifiers that the user himself defines. An isolating identifier isolates the civil status and identity, known to the service provider, from the content provider which knows only the isolating identifier.

The services that the gateway may place at the disposal of the content providers are localization services, services providing information on the apparatus used by a user to get connected to the content provider as well as services relating to wallet functions, bank accounts, visiting cards, delivery address information and the like.

### SUMMARY OF THE INVENTION

An object of the invention therefore is a method for the management of a configuration of behavior of a gateway of a service provider according to the wishes of a user accessing a content provider through the gateway of the service provider, wherein:

the gateway has means to access a user-related recording that includes a description of the behavior that the user wishes the gateway to adopt, as a function of an identifier of the content provider,

the gateway accesses the user-related recording through a first user identifier, when the user sends a request to the content provider,

the gateway accesses the user-related recording through a second isolating user identifier, during the reception of a request, concerning the user, for service on the part of the content provider,

the gateway has means to link the first and second identifiers.

### BRIEF DESCRIPTION OF THE DRAWINGS

The invention will be understood more clearly from the following description and the accompanying figures which are given purely by way of an indication and in no way restrict the scope of the invention. Of these figures:

FIG. 1 illustrates means useful for the implementation of the method according to the invention;

FIG. 2 illustrates a scenario implementing the method according to the invention.

### MORE DETAILED DESCRIPTION

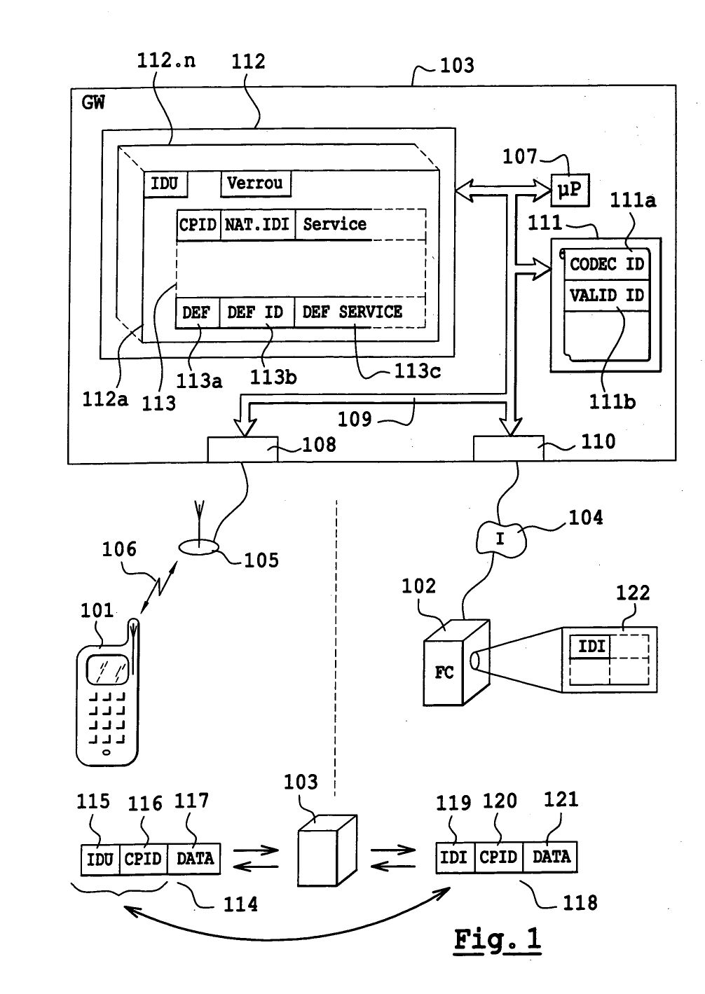

FIG. 1 shows an apparatus 101 by which a user can get connected to a server 102 of the content provider through a gateway 103 of a service provider providing access to a multimedia network 104.

For the purposes of the description, the apparatus 101 is deemed to be a mobile telephone 101. This telephone therefore gets connected to a base station 105 through an RF link 106 of a mobile telephony cell network. The base station 105 is connected to the gateway 103 of the service provider. In the example, the service provider is also a mobile telephony operator. It is this operator that manages the base station 105.

In the description, the network 104 is deemed to be the Internet. In practice, it could be any network used to connect the server 102 of the content provider to the gateway 103. Such a network could very well be, for example, a switched telephony network.

On the cell telephony network, the user of the mobile telephone 101 is identified by a user identifier which is his telephone number. This telephone number therefore enables anyone to associate a physical person with this user identifier. Indeed, it is through this user identifier that the user is contacted on his telephone.

FIG. 1 shows that the gateway 103 has a microprocessor 107. The gateway 103 also has interface circuits 108 with the base station 105. The circuits 108 are connected to the microprocessor through a bus 109.

The gateway 103 also has interface circuits 110 for interfacing with the Internet 104. The circuits 110 are connected to the bus 109. The role of the interface circuits is to provide for compatibility of the signals between the exterior of the gateway 103 and the signals flowing on the bus 109.

The gateway 103 also has a program memory 111. The memory 111 has instruction codes by which the gateway 103, namely the microprocessor 107, can carry out actions. The memory 111 has a zone 111a comprising instruction codes for the encoding and decoding of the identifiers. The memory 111 also has a zone 111b for the validation of the identifiers. Briefly here, the zone 111a makes it possible to protect a user's privacy by converting the user identifier into an isolating user identifier. The zone 111b enables the gateway 103 to take account of the user's wishes concerning the management of his privacy.

The gateway 103 also has a user memory 112. The memory 112, like the memory 111, is connected to the bus 109. The memory 112 is in fact a user database pooling at least the information relating to the management of the users'privacy. The memory 112 is subdivided, for the purposes of the description, into recordings. A recording may be a file, or a piece of a file, in a digital memory. There are therefore, preferably, in the memory 112 as many recordings as there are users liable to use the gateway 103 to get connected to a content provider. Each recording then corresponds to a user/subscriber. However, it may happen that a user/subscriber is not associated with a recording. In this case, there is a default recording that is associated with all the users/subscribers who do not have a recording of their own in the memory 112. The structure of only one recording 112a shall be described since all the recordings have the same structure.

A recording 112a has a first field IDU used to record the user identifier. The field IDU therefore preferably has a telephone number of a user subscribing to the operator managing the gateway 103.

It is the field IDU that provides access to the right recording. A recording 112a has a table 113. The table 113 is structured in rows and columns. Each row corresponds to a content provider and each column corresponds to a piece of information on the content provider. The table 113 has a column 113a used to record a content provider identifier. Such a content provider identifier is, for example, an Internet address or a URL (Universal Resource Locator), a telephone number an IP address, or electronic address in general.

The table 113 has a second column 113b corresponding to the nature of the isolating identifier that the user associates with the content provider. A column 113c enables the user to associate a list of services with the content provider. The service is contained in this list of services that the gateway is allowed to render to the content provider when the service request relates to the user identified by the IDU field.

The gateway 103 therefore has an intermediate role between the apparatus 101 and server 102. As a rule, the gateway 103 receives and/or sends out frames 114 from and/or to the apparatus 101. In addition to data useful to communication between the service provider and the user, a frame 114 comprises a field 115 identifying the user, a field 116 identifying the content provider and a field 117 of conveyed data. The gateway 103 furthermore receives and/or sends frames 118 from and/or to the server 102. In addition to the data useful for communication between the service provider and the content provider, the frame 118 comprises an isolating user identifier field 119, a content provider identifier field 120 and a field 121 of transported data. Through the instruction codes of the zone 111a, the gateway 103 sets up a link between, firstly, the fields 115-116 and, secondly, the field 119. In practice, the fields 116 and 117 respectively are identical to the fields 120 and 121 respectively.

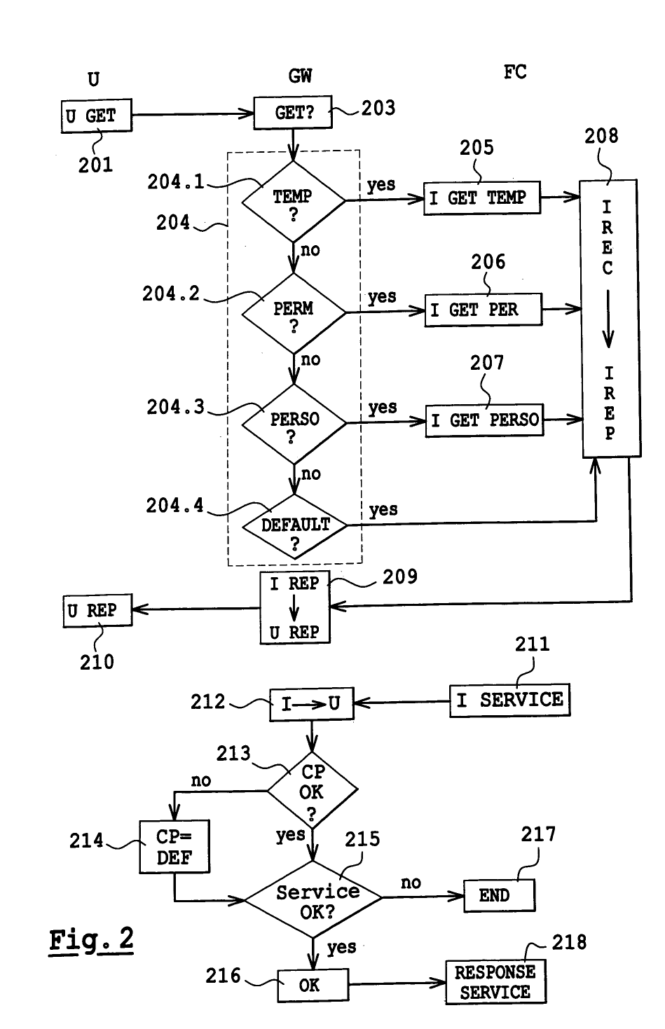

FIG. 2 shows a preliminary step 201 in which the user of the apparatus 101 uses this apparatus to send a request for a content provider. For the example, it is assumed that the request sent at the step 201 is a GET type request according to an HTTP (hyertext transfer protocol) type protocol. The request of the step 201, or request UGET, is therefore sent out by the apparatus 101 and received, in the step 203, by the gateway 103. The request UGET is of the type corresponding to the request of the frame 114.

In the step 203 the gateway 103 accesses the user identifier 115 of the request UGET. This user identifier 115 enables the microprocessor 107 to retrieve a recording in the memory 112. Furthermore, through the request UGET, the microprocessor 107 accesses the identifier 116 of the content provider. This enables the identification of a row in the table 113. This identified row then provides information on the nature of the isolating identifier that the gateway 103 must produce. The operation passes to a step 204 to determine the nature of the isolating identifier to be produced. In the step 204 of the example, there are four possibilities. A first possibility 204.1 corresponds to an identifier nature relating to an isolating temporary or isolating session identifier. A step 204.2 corresponds to an identifier nature relating to a permanent or context identifier. A step 204.3 corresponds to an identifier nature relating to an isolating personalized identifier. And finally a step 204.4 corresponds to a default identifier nature. The step 204.x that is implemented is determined by the presence or non-presence of the identifier 116 in the table 113. If the identifier 116 is not in the table 113, then the invention uses a specific row of the table 113 which corresponds to the default behavior. If the identifier 116 of the content provider is present in the table 113, then the field 113b provides information on the nature of the identifier, and hence on the step 204.1-204.3 implemented.

From the step 204.1, the operation passes to a step 205 for the production of a frame IGET with a temporary identifier. From the step 204.2, the operation passes to a step 206 for the production of the frame IGET with a permanent identifier. From the step 204.3, the operation passes to a step 207 for the production of the frame IGET with a personalized identifier. From the step 204.4, a frame IGET is produced with an identifier corresponding to the default identifier nature specified by the table 113.

In the steps 205 to 207, the gateway 103 produces a frame IGET corresponding to the frame 118. What differentiates the steps 205 to 207 is the nature of the isolating user identifier produced to enter information in the field 119.

A temporary identifier is, for example, a date associated with the user identifier. Such a date is, for example, the UNIX also known as the UNIX timestamp. This is the number of seconds that have elapsed since 0H00 on Jan. 1, 1970. Such a date, associated with the user identifier 115 and then encrypted, makes it possible to provide information on an identifier field of an isolating user identifier.

In the step 206, the isolating user identifier field produced corresponds, for example, to the field 115 encrypted according to an algorithm known to the gateway 103 only. In one variant, the field 115 is associated, before encryption, with a content provider code corresponding to the content provider identifier 116. Thus, an identifier field is obtained for the isolating user identifier which is a function both of the user and of the content provider that he is seeking to contact.

In the step 207, the identifier field of the isolating user identifier then corresponds to a value specified by the user.

In the step 206, a content provider code is associated with the content provider identifier, for example through a table not shown in FIG. 1.

Once the identifier field of the isolating user identifier has been produced, the isolating user identifier is supplemented, preferably, by a field indicating the nature of the isolating identifier and by a field indicating the operator that has produced the identifier. The last two fields are optional but enable the content provider, through the server 102, to manage the isolating user identifiers more efficiently.

From the steps 205 to 207 the operation passes to a step 208 of reception of the frame IGET by the server 102. In the step 208, the server 102, has access to the field 119. This enables it to consult a table 122. This table 122 is a user table. It is divided into rows and columns. Each row corresponds to a user identified by an isolating user identifier, and each column corresponds to a piece of information on the user.

In the example, it can be seen that the only means, for the content provider, to associate information with a user is to do it through an isolating user identifier. Now the only entity capable of associating the isolating user identifier with the physical user is the service provider, through the gateway 103. The user's privacy is therefore well protected by the service provider. The content provider is limited to an isolating identifier relating to a single user for the lifetime of the isolating identifier: this isolating identifier then identifies an individual only formally and not in terms of civil status and identity. The content provider therefore does not know who is getting connected to its server. The user thus has the assurance that the content provider will have knowledge only of the information that the user will have himself explicitly provided to the content provider during a connection made in using an isolating identifier. The collected information is then associated solely with the isolating identifier.

In the step 208, the server 102 can record the information in the table 122 and/or produce a response IREP intended for the user. The response IREP is then the response to the received request IGET, the request IGET being itself a transposition of the request UGET.

From the step 208, the operation passes to a step 209 for the reception/translation of the frame IREP into a frame UREP through the gateway 103. This translation step 209 corresponds to the conversion of the isolating user identifier into a user identifier. The frame is then transmitted to the apparatus 101. In the step 210, the apparatus 101 receives the frame UREP, and responds to the frame UGET.

Inasmuch as an isolating user identifier has been produced by the gateway 103, or comprises a nature field, the gateway 103 is capable of inverting the process that has produced the isolating user identifier. Only the entity that has produced the isolating user identifier can carry out the inversion. This inversion enables access to a user identifier, hence to a recording in the memory 112. In the case of a temporary isolating user identifier, this inversion gives access to a date and hence makes it possible to determine the date of the temporary isolating identifier, and therefore its validity as a function of a maximum lifetime for an identifier of this kind.

In a step 211, from an isolating user identifier, the content provider, working through the server 102, may send out a service request ISERVICE. The service request is then of the request 118 type. The request ISERVICE is received by the gateway 103 at the step 212.

From the request ISERVICE, the gateway 103 is capable of retrieving an isolating user identifier. From the isolating user identifier, the gateway 103, using the instruction codes of the zone 111a, can produce a user identifier and hence determine a recording in the table 112.

The field 120 of the frame ISERVICE enables the gateway 103 to determine a row in the table 113 corresponding to the user identified by the field 119: this is the step 213 for determining the content provider. If the identifier of the content provider is present in the table 113, the microprocessor 107 can then determine a list of services authorized for the content provider through the column 113.c, and the operation passes to a step 215 for validating the service required. If the identifier of the content provider is not in the table 113, the operation passes to a step 214 of retrieval of the list of services authorized by default, which will replace the list of services authorized for the request ISERVICE. From the step 214, the operation passes to the step 215. Should the default list of services comprise all the possible services, additional locks are provided. These additional locks correspond to a policy proper to the service provider. Thus, if all the services, or certain predefined services, are activated by default, a condition can be laid down on the nature of the isolating identifier, or the content provider to enable access, for example, to the localization service. A localization is then provided only if the isolating identifier is, for example, a temporary identifier. These additional locks may be eliminated user by user and by an explicit action of the user concerned. A lock is therefore a test performed in the nature of the isolating identifier, or on the value of the identifier of the content provider, during the step 214. This test may be deliberately deactivated by the user. This lock takes the form of the field VERROU of the table 112.x. The fact that action is required on the part of the user to update this field VERROU means that the user cannot claim not to have been informed of the behavior adopted by the gateway since he has himself parametrized this behavior. In one variant, the field VERROU can be replicated into as many fields as there are services that can be made available by the gateway.

To designate all the services, either a list is defined for which it possible to count the elements and for which the total number of services is known, in which case it is possible to determine whether a list comprises all the services, or else a predefined code equivalent to the designation of all the services is used.

In its field 121, the request ISERVICE comprises a service identifier. The gateway 103 then determines whether this service identifier is on the list of authorized services. This is the step 215. If the service is not authorized, the operation passes to an end step 217 and no response will be made, unless it is a negative response, to the request ISERVICE sent at the step 211. If the service is authorized, the operation passes to a step 216 in which the gateway 103 produces a response to the services called for by the server 102 or undertakes actions in response to these requests.

In a step 218, the server 102 receives a response to the request sent at the step 211.

In practice, the encryption algorithms used are symmetrical secret-key algorithms. Known algorithms in this group include the DES (Data Encryption Standard), 3DES and AES (Advanced Encryption Standard) algorithms. Other equally valid algorithms exist.

A user, who is a subscriber to the operator managing the gateway 103, may get connected to said gateway in order to update the contents of the recording of the memory 112 that corresponds to him. The operator decides on the policy of access to the recordings. The access may be free or subject to the payment of a fee. Similarly, the access may be through an interface by which the user can get directly connected to the gateway 103, or it may be made through a written or verbal request to a person responsible for the maintenance of the memory 112.

Such an updating takes place, for example, as follows: the user sends a request to the gateway 103 for the downloading of the recording that corresponds to him. If the user is authorized to send such a request, then the response to the request comprises a file corresponding to the recording asked for. The user then edits the requested recording on the apparatus 101. Once the editing is completed, the edited recording is sent back to the gateway 103 for the updating of the memory 112. This updating too is subjected to a fee. These fees are managed by the gateway 103 as a function of the user identifier.

In one variant of the invention, the recordings of the memory 112 are distributed among the apparatuses of the subscribers with the operator managing the gateway 103. When the microprocessor 107 wishes to consult a recording, it must make a request for this to the apparatus on which said recording is recorded, i.e. the user's apparatus.

In one variant, the user database 112 is recorded not on the gateway 103, but in a memory of another server (not shown) which may then be interrogated by the gateway 103.

What is claimed is:

1. A method for the management of a configuration of behavior of a gateway of a service provider according to the wishes of a user accessing a content provider through the gateway of the service provider, wherein:
the gateway has means to access a user-related recording that includes a description of the behavior that the user wishes the gateway to adopt, as a function of an identifier of the content provider,
the gateway accesses the user-related recording through a first user identifier automatically known on the network and provided by the service provider, when the user sends a request to the content provider,
the gateway comprises a default recording related to all the users who have not a user-related recording,
the gateway accesses the user-related recording through a second isolating user identifier, during the reception of a request, concerning the user, for service on the part of the content provider,
the gateway has means to link the first and second identifiers.

2. A method according to claim 1, wherein a user-related recording associates the first user identifier with at least one content provider identifier, a content provider identifier being associated with a nature for the second isolating identifier to be given to the content provider when the service provider relays a request from the user to the content provider.

3. A method according to claim 2, wherein the nature of the second isolating identifier is chosen from among at least the group formed by temporary, permanent or personalized identifiers.

4. A method according to claim 1, wherein a user-related recording associates the first user identifier with at least one content provider identifier, a content provider identifier being associated with at least one service that the service provider is then authorized to place at the disposal of the content provider.

5. A method according to claim 1, wherein a user-related recording comprises a description of a default behavior for the gateway, the default behavior being adopted by the gateway when it is no longer possible to associate the user with a content provider.

6. A method according to claim 1, wherein the user-related recording is recorded in a user database interrogated by the gateway.

7. A method according to claim 6, wherein the user gets connected to the user database to update the recording concerning him.

8. A method according to claim 1, wherein the user-related recording is recorded in a terminal of the user, the gateway interrogating this terminal to obtain the user-related recording.

9. A method according to claim 1, wherein a default behavior of the gateway is locked by a lock that has to be opened explicitly by the user.
